(19) United States
(12) Patent Application Publication
(10) Pub. No.: US 2013/0246277 A1
(43) Pub. Date: Sep. 19, 2013

(54) Copyright Protection System And Royalty Processing System

(71) Applicants: Michael Christian Moseley, Panama City, FL (US); James Vemeard Campbell, Panama City, FL (US)

(72) Inventors: Michael Christian Moseley, Panama City, FL (US); James Vemeard Campbell, Panama City, FL (US)

(21) Appl. No.: 13/418,808

(22) Filed: Mar. 13, 2012

(51) Int. Cl. G06F 21/00; G06Q 30/00

(52) U.S. Cl. 705/58; 705/59; 705/57

(57) ABSTRACT

The present invention provides a method and system for protecting image data transmitted over a network and processing royalty for image usage. This method and system comprises a secure web server with a valid certificate to host all transactions. The method and system keeps the encrypted file which are provided by an image provider (e.g. publishers of copyrighted materials) on the web server and leases the file to the customers (e.g. manufacturers of finished art). The method and system also comprises a proprietary (FREE) encryption software that enables the image providers to encrypt and upload the image file on the website. The method and system further comprises a proprietary (FREE) decryption printing software that enables the customers to download, decrypt, print the image file and enables the system to track the transaction details.

### BACKGROUND OF THE INVENTION

1. Field of the Invention

The present invention relates to a method of and system for protecting copyright of digital data, and more particularly to a method of and system for protecting image data transmitted over a web-based network as well as processing royalty for image use.

2. Description of Related Art

The fine art and photography industry faces issues of copyright violation from unlawful duplication of their works. The standard and accepted business practice for these publishers and artists to sell their work is in the form of printed photographs and lithographs. Violators can gain access to these reproductions as easy as purchasing a copy from a respected wholesaler or retailer and simply scan and reproduce the work at will. With the large format printing industry making great strides to make equipment and consumables more affordable, many manufacturers of finished art (i.e. framed) are starting to print art in house for more control over cost and time. Unfortunately for them, publishers and artists are reluctant to release the digital content to these manufacturers because of the lack of security and inability to be sure they are being fairly compensated.

While all of the various patents available offer some sort of copyright protection, they rely heavily on the two parties having moral character in lieu of absolute control. Some patents encrypt digital files with a “maximum” value and once that value is reached, it is revoked.

Although there are many patented processes for encrypting digital media for copyright protection, nothing is available specifically for the wide format printing industry with respect to art publication. Image files are generally encrypted and sent to the authorized user for an un-tethered and un-monitored usage. Furthermore, all research indicates that the actual image files are sent to and stored on the end users computer.

Therefore, there exists a need for a method and system that gives the copyright owner the security necessary to release the print ready files to the manufacturers of finished art thus opening up another lane of commerce for their work while saving the manufacturer time and money.

### SUMMARY OF THE INVENTION

The present invention provides a method and system for protecting image data transmitted over a network and processing royalty for image usage. This method and system comprises a secure web server with a valid certificate to host all transactions. The method and system keeps the encrypted file which are provided by the image providers (e.g. publishers of copyrighted materials) on the web server and leases the file to the customers (e.g. manufacturers of finished art). The method and system also comprises a proprietary (FREE) encryption software that enables the image provider to encrypt and upload the image file on the website. The method and system further comprises a proprietary (FREE) decryption printing software that enables the customers to download, decrypt, print the image file and enables the system to track the transaction details.

This system's process allows the customers to manipulate the file to a specified size and to send the file directly to the printer's driver. Therefore, the system can accurately calculate the measurement units and charge accordingly per unit and per copy. Customers are required to purchase “credits” to be used to transact print jobs. These credits are kept in escrow and paid to the owner of the image files being reproduced.

The method and system allows the image file providers to upload their high resolution files and create a “gallery” of their work and post them to our website for customers to browse. When a customer determines they want to “License” an image for reproduction, they must first request permission from the owner to use the file. Once the owner approves the license, the image information and restrictions are recorded into a web server. This transaction information is directly linked to the full size encrypted file. With the decryption printing software connected to the web server holding the various transactions, the customer can see each of their approved licensed files and select one to reproduce. The file is then “streamed” to their computer and placed in the random access memory (RAM) which is not readily available to the customer. The actual image file is only stored in the RAM until the transaction is complete. The decryption printing software displays the image and allows the customer to edit the file. Once the customer is satisfied with their editing results, a request is sent to the “approved” output device (printer). The decryption printing software first checks the customers restrictions as specified by the image provider (i.e. size limits, quantity limits, date limits). If the provider's restrictions have been met, the encryption software checks the customer's account of pre-paid credits. If sufficient credits exist, the job is sent successfully to the output device. At that point, the image file is removed from the memory is and no longer available to the end user unless the licensing agreement dictates further usage. Regardless of the details of the license agreement, the usage is metered and charged for each and every use. The transaction details are recorded on the web server.

Although this invention will not stop unauthorized copies finding their way to the marketplace, it certainly gives the image providers the security necessary to release the print ready files to the manufacturers, thus opening up another lane of commerce for their work while saving the manufacturer time and money.

All transactions are hosted on a secure server with a valid certificate. All database transactions are stored on the working webserver as well as mirrored to alternate servers for security of data. An image provider can configure the “gallery” on the website to eliminate all of the licensing duties for globally approved customers. However, if the situation arises that an image provider needs to license an image on a special circumstance, they may do so directly from their Encryption software.

The system provides a solution for every possible scenario that could arise in a business transaction. The image provider can control who gets their work, how much they get, and how much they pay ensuring that the image provider gets paid for the usage of their image file content.

Alternatively, plugin software can be developed for industry standard programs like Photoshop or RIP softwares. This could allow for the customer to use their regular image editing software but maintain the security and transaction communication to the webserver. Without some type of security plugin for these applications, users could open the decrypted file and “save-as” to create a duplicate of the image file. Furthermore, printing to a virtual (PDF) printer will also create an unauthorized copy of the image file. With the decryption printing software handling all of the image manipulation and printing, the ability to save or print to an unauthorized device driver is controlled.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow diagram illustrating a licensing method 100 for file encryption and uploading to the website.

FIG. 2 is a flow diagram illustrating a licensing method 200 when a customer elects to license digital image file for reproduction from online galleries (catalog).

FIG. 3 provides a flow diagram of a file decryption and printing method 300 that facilitates and effectuates download, decryption, printing, and reproduction of the licensed encrypted image files.

### DESCRIPTION OF THE PREFERRED EMBODIMENT

The method of and system for protecting the copyright of digital images and processing royalty includes providing a website which is a standard shopping cart site where an image provider can edit information about themselves, review current licenses (accounts and images), and run various transaction reports. The web server (website) also allows end users who may be the manufacturers of finished art (i.e. framed) to browse an image provider's information page and gallery, purchase print credits, initiate license agreements with the image provider, initiate license agreements for the images, communicate with the service image provider (company), view account information, view current license information, and run various transaction reports.

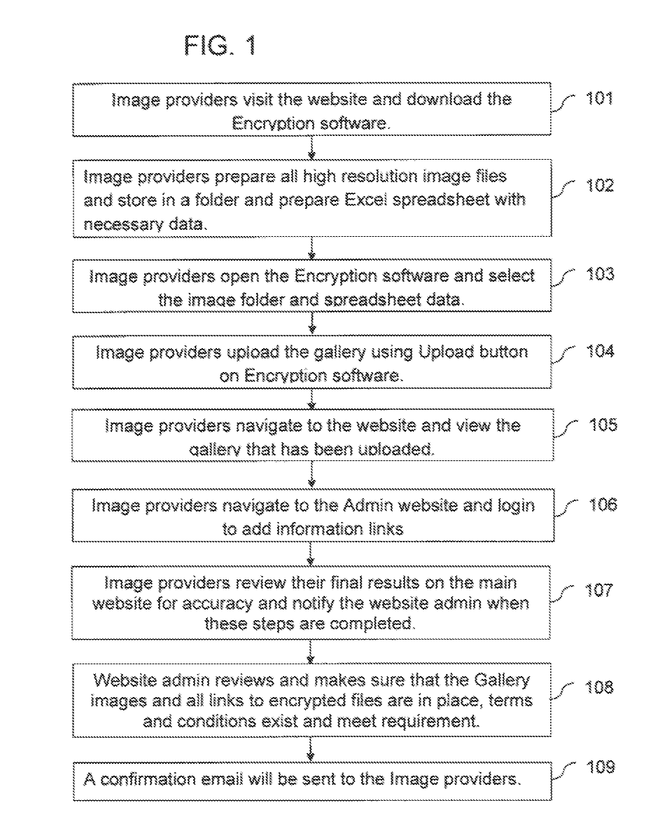

When an image provider first comes to the website, they need to download from the web server and install the encryption software into their computers, register software, and agree to the website and company terms and conditions. Then they set up Gallery images and data for the website. FIG. 1 provides a flow diagram of a method 100 for file encryption and uploading to the website. The method 100 starts at 101 where the image provider visits the website and download the encryption software followed by the step 102 where the image provider prepares all high resolution image files and copy them to a specific directory and prepare an Excel spreadsheet with the necessary data for each image, for example, item number, description, license type (global or per request), image name reference (file name of related high resolution image, publisher ID (as assigned), orientation of image (vertical, horizontal, square), image categories (separated by “|” symbol), artist name, and image release date. After the high resolution image files are prepared with the necessary data, the image provider opens encryption software and select the proper folder location of high resolution image files and the full Excel spreadsheet of the data at step 103. Then, they upload the gallery using the upload gallery button on software at 104. Image files will be encrypted prior to uploading. This could take several minutes depending on the number of images being processed. Next, the image provider navigates to the website with any web browser and navigate to their publisher information and gallery page to review gallery that has been uploaded at 105. The image provider continues to navigate to the administrator website and login with supplied credentials to add information links for desire information such as “about us”, “terms and conditions”, “contact us”, etc. at 106. Afterwards, the image provider reviews their final results on the main website for accuracy and notifies the website administrator when these steps are completed at 107. The website administrator will then review and make sure that the gallery images and all links to encrypted files are in place, terms and conditions page exists and meets requirements and adequate contact information is available for customers at 108. A confirmation email will be sent to the image provider to confirm the activation of their galleries on the website at 109.

The encryption software serves several purposes. First, it gives the image provider the tools to license their work to a specific user. The encryption process allows the owner to encrypt the high resolution file so that is not a usable file for any “normal” image processing software and upload it to the encrypted image server. The software allows the image provider to specify a specific end user that has the ability to use the file, and specify item details such as item number, description, artist, etc. It also enables the image provider to limit the quantity of reproductions, the size of printed output, and the dates that the file will be available to the end user. The image provider can also use the software to specify a royalty amount per square inch or per print if size specific. Moreover, the encryption software allows the image provider to create a “gallery” of their work on the website. The software will automate the process of uploading the encrypted high resolution files and building the database that will drive the online gallery. Details of each product will play a role in the website's ability to automatically license images to “approved” customers. This portion of the system will be further outlined.

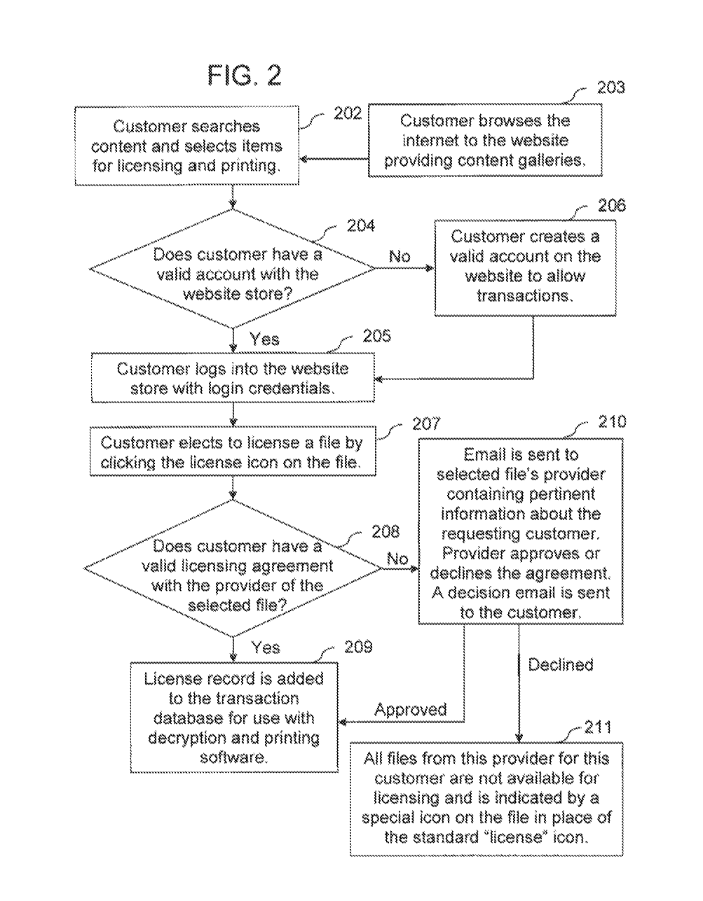

FIG. 2 provides a flow diagram illustrating a licensing method 200 when a customer elects to license digital image file for reproduction from the online gallery (catalog). The licensing process commences at step 202 where a customer goes to the website to browse available images either by comprehensive gallery of “ALL” images on the website or may choose to browse the gallery by individual image provider. Customer can search content and select items for licensing and printing. The customer may add selected images to “My Gallery” (not necessary for licensing purposes) and select selected images to license from the image provider at step 203. Following the customer's selection, the website store will determine if the customer have a valid account at step 204. If the customer already has a valid account on the website, the customer can log into the website store with login credentials at step 205. If the customer have not created a valid account on the website to allow transactions then the customer creates an account on the website and purchase credits at step 206 after which the method flow proceeds to step 205. Afterwards at step 207, 208, and 209, the customer may elect to license a file by clicking the license icon on the file. The web server then decides whether the customer have a valid licensing agreement with the image provider of the selected file. If an image provider-customer agreement exists, the web server allows for license image per agreement. If the agreement does not exist, web server will process agreement request on behalf of the customer to the image provider. An email is sent to the selected file's provider containing pertinent information about the requesting customer at block 210. The image provider receives email from the web server with a link to the agreement request. The image provider clicks the link to reveal submission form data that includes: customer name, customer contact info (address, phone, email, etc.), customer market info (use of your images), customer type (manufacturer, wholesaler, retailer, etc.). Once the image provider investigates the customer and decides on approval status, they will use the same submission form to input the required fields: approved (yes/no), status (global or per image), pricing per square inch (if global), and limitations (size, quantity, date range). A decision email is sent to the customer. If the image provider approves the agreement, the customer and owner enter into an “agreement” to use the offerings.

As a result, the images selected by the customer are licensed with the above attributes and the license record is added to the transaction database for use with decryption and printing software at step 209. If the image provider declines the agreement, all files from this image provider for this customer are not available for licensing and is indicated by a special icon on the file in place of the standard “license” icon at step 211.

Moreover, the website can be designed to be a self licensing entity of its own. When a customer elects to generate an “agreement” for licensing images from a particular image provider, that owner will have an opportunity to review the customer and the methods with which the customer intends to use the images. The image provider can approve or deny the request and specify if the approval is “global”, (meaning the customer can have access to any item in their gallery) or “per image”, (meaning the user will need to go through the licensing process on an image by image basis). The image provider can also specify a particular image as being licensable on a “global” or “per request” basis. Therefore, if a customer is approved globally by the image provider and they select an image that is “globally licensable”, the customer can then have the web server create the license automatically without intervention from the image provider. If the customer or the image desired is not set to “global”, the image provider will be sent additional requests to be approved or denied. The web server's primary function is to store the customer, image provider, and file data and make decisions on licensing based on the values of those records. Another primary function of the web server is to host all of the various transactions that occur between the customers, and the image provider as well as initiate email communications to all parties involved for the licensing and purchase transaction decisions.

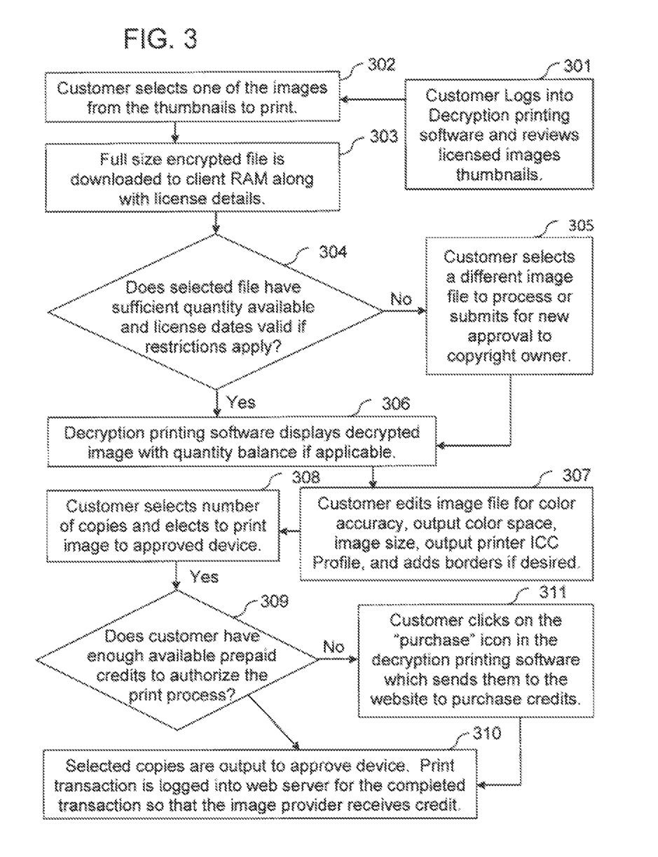

After the license is approved, the customer needs to download, install the Decryption Printing software from the website in their computer, and register the software with the web server so that their computer can connect to the licensed image file, and download and use the image file for reproduction. The customer registers the software with the web server to connect to licensed image data. FIG. 3 provides a flow diagram of a file decryption and printing method (software) 300 that facilitates and effectuates download, decryption, printing, and reproduction of the licensed encrypted image files. The file decryption and printing process 300 commences at 301 where the customer logs into decryption software and the software will display image thumbnails of all images that have been licensed to them for reproduction to review. Then, the customer selects one of the images from the thumbnails to print at 302. Selecting one of the images from this view will automatically “stream” the high resolution encrypted file from the webserver containing the image content to the Random Access Memory (RAM) of the customer's computer, displaying the image in the viewer along with license details. This streamed image file is not readily available to the customer at 303. The license details include the item number, description, image size (fixed if specified), the embedded width, height, and DPI, remaining copies available (if restricted), and cost per print (calculated by the cost per sq. inch×sq. inches or total cost (if specified). If there are restrictions applied, the decryption software will inform the customer whether there are sufficent quantity of the selected file available and whether the license dates are still valid at 304. If no, the customer selects a different image file to process or submits for new approval to image provider at 305. If yes, decryption decrypts and displays the decrypted image with quantity balance if applicable at 306.

The software allows the customer to modify image using the decryption software's manipulation tools. It is robust with many of the same features that you find in applications such as Photoshop. Image editing is minimized so that a customer cannot detract from the original art but mainly adjust to edit image file for color accuracy, output color space, image size, and adds borders if desired and as needed with their printing workflow 307. If the customer resizes the original image, the cost of the print will be recalculated to the current value based on the new square inches. The customer will also assign the output ICC profile and color management of the printer so as to maintain color accuracy on output. Customer then selects the number of copies, the approved output device (printer) 308.

The decryption printing software will determine if the customer have enough available prepaid credits to authorize the print process at 309. If yes, the image will be sent to the output device 310. Prior to printing, the customer may review and confirm the transaction details which include the cost of the output, current print credits on file, and available print credits after this output. The customer will also have to check the box confirming that they agree with the image provider and website Terms & Conditions. After all the confirmation, the job is printed.

At the time, the decryption device takes a snapshot of the customer's account, deducts the credit usage from their account, reduces any quantity counts from the quantity limitations, then takes another snapshot of their account to create an XML script of the differences between the snapshots and records it on the transaction server.

Print transaction data is logged into web server database for the completed transaction so that image provider who is the image provider can be compensated based on transaction log of their files at 310. This data will include, but is not limited to information such as IP address of requesting computer, customer ID, license ID (a record that was created for the image that is being used at the time), quantity of copies, value of each copy (in credits), total value of this job (quantity×credits each), XML script for any changes in color, size, or additional border detail (for later recall), job timestamp, driver details (media type used for output, printer model, etc.).

If no, the customer clicks on the “purchase” icon in the decryption printing software which sends them to the website to purchase credits at 311. Once enough credits for the job printing is purchased, the customer can continue the transaction at 310.

The image provider has the ability to revoke or edit the current licenses of their works. If an item becomes unavailable or the license needs to be edited or revoked, the owner can log into the transaction server and make those changes. If the file is being removed for reasons other than misuse, they must initiate a revocation process with a period time, preferably 30 days. Initiating this process will notify each licensee of the change so they can take appropriate action to replace the file if needed.

Alternatively, plugin software can be developed for industry standard programs like Photoshop or RIP Softwares. This could allow for the customer to use their regular image editing software but maintain the security and transaction communication to the webserver. Without some type of security plugin for these applications, users could open the decrypted file and “save-as” to create a duplicate of the image file. Furthermore, printing to a virtual (PDF) printer will also create an unauthorized copy of the image file. The current system's decryption printing software handles all of the image manipulation and printing, thus preventing the ability to save or print to an unauthorized device driver.

While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A system for protecting image data transmitted over a network and processing royalty for image use comprising:
a website and webserver which includes browsable galleries of high resolution image files and providing services for allowing an image provider to electronically upload encrypted high resolution image files to the website gallery and allowing a customer to electronically purchase the high resolution image files from the galleries;
an encryption software which gives the image provider the tools to license their work to a specific user, the encryption software allows the owner to encrypt the high resolution image file so that it is not a usable file for any “normal” image processing software and uploads it to the secure image server;
a decryption and printing software which streams the encrypted high resolution image file licensed to the customer user from the webserver data to the random access memory (RAM) of the customer's computer, decrypts it to display the image in the viewer and outputs to an approved printer.

2. The system of claim 1 wherein the website allows the image provider to edit information about themselves, review current license, and run various transaction reports.

3. The system of claim 1 wherein the website allows the customer to browse the image provider's information page and gallery, purchase print credits, initiate license agreements with the image provider, initiate license agreements for the images, communicate with the service provider, view account information, view current license information, and run various transaction reports.

4. The system of claim 1 wherein the webserver stores the customer, image provider, file data and makes decisions on licensing based on the values of the records, hosts all of the various transactions that occur between the customer and image provider, as well as initiates email communications to all parties involved for the licensing and purchase transaction decisions.

5. The system of claim 1 wherein the webserver determines whether the customer is authorized to use the high resolution image files.

6. The system of claim 1 wherein the encryption software specifies item details include but are not limited to item number, description, and artist.

7. The system of claim 1 wherein the encryption software enables the image provider to specify the quantity of reproductions, the size of the printed output, the dates that the file will be available to the customer, global or per request, and a royalty amount per square inch or per print if size specific.

8. The system of claim 1 wherein the encryption software automates the process of uploading the encrypted high resolution files and building the database that will drive the online gallery.

9. The system of claim 1 wherein the decryption printing software retrieves information from the web server including but not limited to item number, description, image size, remaining copies available, and cost per print.

10. The system of claim 1 wherein the decryption printing software retrieves information from the web server for available balance on credit account which gives the customer a clear view of their credit balance when processing a file for reproduction.

11. The system of claim 1 wherein the decryption printing software initiates transaction records to be stored in the database and later used for paying the artist or publisher royalty.

12. The system of claim 11 wherein transaction information about each print job to be entered into the record and stored on the web server database includes but is not limited to customer ID, license ID (a record that was created for the image that is being used at the time), quantity of copies, total value of this job, XML script for any changes in color, size, or additional border detail, and various driver details (media, printer model, etc.).

13. A method of protecting image data transmitted over a network and processing royalty for image use comprising:
providing a website system that includes browsable galleries of high resolution image files and providing services for allowing an image provider to electronically upload encrypted high resolution image files to the website gallery and allowing a customer to electronically purchase the high resolution image files from the galleries;
in response to a request from the image provider, generating business terms between the website and image provider and transmitting the business terms to the image provider as well as providing the image provider an encryption software which automates the encrypting process and uploading of the high resolution image files and building the database that will drive the online gallery;
storing and displaying the encrypted image files and necessary data for each image on website galleries, the necessary data including whether the image is licensable on a global or per request basis;
creating an account and selling credits to the customer in response to a request from the customer;
sending customer's agreement request to the image provider and providing the image provider the customer's information and the customer's intended use of the image for review;
offering the image provider an option to deny or approve the customer access request to be global or per image;
notifying the customer with one of the approval status, either globally or per image or denied;
providing decryption printing software;
automatically generating a license for the selected image file;
streaming the licensed high resolution encrypted file and sending to the random access memory (RAM) of the customer's computer, displaying the image in the viewer, and populating the information fields corresponding to the image;
retrieving and displaying balance information on customer's credit account, calculating cost for printing after the customer electing number of copies and electing to print image to approved device, and determining if the customer have enough available credits to authorize the print process; and
recording and storing print transaction data about each print job on the web server database and later used for paying the artist or publisher royalty.

14. The method of claim 13 wherein the license for the selected image file does not need intervention from the image provider if the customer is globally approved and the image file selected is globally licensable.

15. The method of claim 13 further comprising getting the image provider's approval for the license for the selected image file if either the image file selected is not globally licensable or the customer is not granted global access.

16. The method of claim 13 further comprising:
mirroring current “license” that are in place with each image provider.

17. The method of claim 13 further comprising reviewing the image provider's website, making sure that the gallery images and the links to encrypted files are in place, terms and conditions exist and meet requirement, and notifying the image provider the activation of their gallery on the website.

18. The method of claim 13 further comprising means for restricting image editing so that a customer cannot detract from the original art but mainly adjust to edit image file for color accuracy, output color space, image size, and adds borders if desired and as needed with their printing workflow.

19. The method of claim 13 further comprising providing the customer tool whereby the customer may review and confirm the transaction details which includes the cost of the output, current print credits on file, and available print credits after this output prior to printing.

20. The method of claim 13 further comprising a plugin software for industry standard editing software programs so that the customer can use their regular image editing software but maintain the security and transaction communication to the webserver.
